(19) United States
(12) Patent Application Publication
(10) Pub. No.: US 2013/0085762 A1
(43) Pub. Date: Apr. 4, 2013

(54) AUDIO ENCODING DEVICE

(71) Applicant: Ryuji MANO, Kanagawa (JP)

(72) Inventor: Ryuji MANO, Kanagawa (JP)

(73) Assignee: Renesas Electronics Corporation, Kawasaki-shi (JP)

(21) Appl. No.: 13/563,615

(22) Filed: Jul. 31, 2012

(30) Foreign Application Priority Data
Sep. 29, 2011 (JP) 2011-214802

(51) Int. Cl. G10L 19/00

(52) U.S. Cl. 704/500; 704/E19.001

(57) ABSTRACT

An audio encoding device capable of efficient encoding processing includes: a storage unit which stores audio data; a data acquisition controller which acquires the audio data from the storage unit; a transformation unit which processes an audio data signal outputted from the data acquisition unit for frequency transformation; a harmonic overtone generation/synthesizing unit which generates a harmonic based on a first output wave out of an output wave of the transformation unit and synthesizes the harmonic and a second output wave out of the output wave of the transformation unit, the second output wave being higher in frequency than the first output wave; and an encoder which subjects an output from the harmonic overtone generation/synthesizing unit to encoding processing.

### CROSS-REFERENCE TO RELATED APPLICATIONS

The disclosure of Japanese Patent Application No. 2011-214802 filed on Sep. 29, 2011 including the specification, drawings, and abstract is incorporated herein by reference in its entirety.

### BACKGROUND

The present invention relates to an audio encoding device, particularly, an audio encoding device which efficiently encodes audio data by generating harmonic overtones of a low frequency component thereof to frequency-shift the audio data and eventually eliminate the low-frequency component.

There are recorders using an encoding device for encoding digital audio PCM (pulse code modulation) data. For audio data encoding, internationally standardized processing based on MPEG (Moving Picture Experts Group), for example, MPEG audio compression processing and AC-3 compression processing are performed.

In a compression processing device based on MPEG1 Audio Layer III, for example, an input signal is divided into sub-band signals which are then subjected to MDCT (Modified Discrete Cosine Transform) processing for transformation into frequency spectrums. The MDCT spectrums obtained are transferred, after having frequency aliasing removed by an aliasing reduction butterfly, to a quantization/Huffman encoder.

In the quantization/Huffman encoder, scale factors are determined, MDCT spectrums are quantized, and quantization indexes are Huffman-encoded. This is done while varying, by repetitive loop processing, the quantization step size and the number of quantization bits for each frequency band and without exceeding the number of usable bits that is determined based on requirements concerning the maximum allowable quantization noise power for each frequency band calculated at a psycho-acoustic sense analysis unit, bit rate, and the number of bits accumulated in a bit reservoir (used to realize a pseudo-variable bit rate).

Side information transferred includes, for example, MDCT transform block length information, quantization step size, scale factor-related information, and information about Huffman encoding region/table.

The above encoding processing poses such problems as: when a large amount of data is to be processed over a wide band, usable bits become generally insufficient resulting in sound quality deterioration and making audio encoding processing inefficient; and, when no high bandwidth becomes available in terms of algorithm, sound quality deterioration results. Techniques for efficiently performing the above encoding processing (quantization) have been disclosed in some patent documents.

In Japanese Unexamined Patent Publication No. 2009-237048, an audio signal interpolation device is proposed. In the audio signal interpolation device, an audio signal which has lost a high-frequency component by being compressed can have a high-frequency component highly correlated with the fundamental tone part of the audio signal interpolated therein, so that, when the audio signal is reproduced with emphasis on a bass tone, the low-frequency noise heard in an ambient area can be reduced. The audio signal interpolation device proposed in Japanese Unexamined Patent Publication No. 2009-237048 includes high-frequency interpolation means for interpolating a high-frequency band in an audio signal, low-frequency emphasis means for emphasizing a low-frequency band of an audio signal to which plural harmonic overtones of a fundamental frequency have been added, and filtering means for removing a predetermined low-frequency component from an audio signal which has been interpolated with a high-frequency component by the high-frequency interpolation means and a low-frequency component of which has been emphasized by the low-frequency emphasis means.

The technique disclosed in Japanese Unexamined Patent Publication No. 2009-244650 is aimed at obtaining sound without much distortion even when a harmonic component based on an input audio signal is added to the input audio signal. The device disclosed in Japanese Unexamined Patent Publication No. 2009-244650 includes a fundamental wave extraction circuit which extracts, from the input audio signal, a fundamental wave component in a frequency band lower than the reproduction frequency band of the speaker included in the device, a harmonic generation circuit which generates harmonics of a fundamental wave band component, a low-frequency level detection circuit which detects the level of a fundamental wave band component as a low-frequency level, a high-frequency component extraction circuit which extracts, from an input audio signal, a harmonic band component higher in frequency than the fundamental wave band component, a high-frequency level detection circuit which extracts the level of a harmonic band component as a high-frequency level, and a control amount calculation circuit which controls, based on the ratio of the low-frequency level to the high-frequency level and a threshold of harmonic generation to cause distortion, the amount of harmonic generation in the harmonic generation circuit so as not to allow harmonics to cause distortion.

The invention according to Japanese Unexamined Patent Publication No. 2000-004163 is aimed at providing a dynamic bit allocation method and device for dynamic bit allocation which can be widely applied to digital audio compression systems and which can be realized at low cost. The bit allocation method and device disclosed in Japanese Unexamined Patent Publication No. 2000-004163 performs very efficient bit allocation processing by focusing attention, using a simplified simultaneous masking model, on the psycho-acoustic behavior of a human's hearing characteristics. In the processing, the peak energy of each unit, i.e. each frequency-divided band, is calculated, and a masking value, i.e. an absolute threshold of hearing when the simplified simultaneous masking effect model is used, is calculated and the masking value calculated is set as an absolute threshold for each unit. Next, the signal-to-masking ratio is calculated for each unit and, based on the calculated signal-to-masking ratio, dynamic bit allocation is efficiently performed.

An equal-loudness curve (not shown) based on the international standard ISO 226:2003 “Acoustics—Normal equal-loudness-level contours” is used to represent a relationship between sound pressure level and frequency. To draw an equal-loudness curve, sound pressure levels at different frequencies which are perceived by a listener as equal loudness (sound magnitude or loudness perceived by a listener) are measured and the measurements are connected thereby plotting a sound level contour line of equal loudness. Hence, the sound levels represented by equal-loudness curves (contours) below a hearing threshold (absolute threshold of hearing or lowest sound-pressure contour) are assumed not audible by humans.

Based on equal-loudness curves, it is known that sound is perceived with high sensitivity (highly audible) at around 1 kHz or in a range of 3 to 5 kHz and that, at other frequencies, perception sensitivity relatively decreases (less audible). In a virtual pitch effect (so-called, missing fundamental effect), sound from which a frequency band inclusive of a fundamental frequency has been removed is perceived as the original sound with its pitch unchanged. This phenomenon occurs because a human's brain perceives the pitch of a sound based not only on a fundamental frequency but also on the ratio of harmonics. For example, when a low-frequency sound correction technique is used, even when a small speaker not capable of reproducing a low-frequency sound below 100 Hz is used, such a low-frequency sound which cannot be reproduced is perceived by a listener. Namely, an original sound which has been removed is perceived by a human hearing harmonic overtones each having a frequency equaling a multiple of the frequency band of the original sound. For example, a listener can be caused to perceive a sound of 50 Hz which does not exist by generating harmonic overtones of the 50-Hz sound, for example, 100 Hz, 150 Hz and 200 Hz harmonic overtones. For this, no 50 Hz sound is required to exist.

### SUMMARY

The inventions disclosed in Japanese Unexamined Patent Publication Nos. 2009-237048 and 2009-244650 each provide a harmonic band generation technique making use of the missing fundamental effect. In the inventions, no concrete method for low-frequency band generation is described.

The invention disclosed in Japanese Unexamined Patent Publication No. 2000-004163 provides an improved bit allocation procedure for making (simultaneous) masking threshold calculations (usually very heavy) less heavy, but the invention provides no concrete method for low-frequency band generation.

When a large amount of data ranging over a wide band is to be processed, the number of bits for use in encoding becomes inadequate and sound quality deterioration results. There are also problems caused when data other than audio data increases, for example, quantization loss (quantization noise) and encoded information redundancy resulting from bit allocation distributed between frequency bands or between scale factor bands (level-information groups).

An object of the present information is to provide an audio encoding device capable of efficient encoding processing.

According to an embodiment of the present invention, prior to encoding processing to be performed by an encoder, information about a low-frequency band (fundamental frequency based on which harmonic overtones are generated for addition to a high-frequency band) is added to a high-frequency band (as harmonic overtones each having a frequency equaling a positive integer multiple of the fundamental frequency) to allow, for encoding processing, the bit allocation to the low-frequency band to be reduced and the bit allocation to the high-frequency band to be correspondingly increased.

According to an embodiment of the present invention, the quantization loss (quantization noise) and encoded information redundancy resulting from bit allocation distributed between frequency bands or between scale factor bands (level-information groups) can be reduced to realize high sound quality and high processing efficiency.

### BRIEF DESCRIPTION OF THE DRAWINGS

FIG. 1 is a block diagram showing an example configuration of an audio encoding device 100 according to a first embodiment of the present invention;

FIG. 2 shows an example of data format configuration for compressed data (stream);

FIG. 3 is a block diagram showing a principal part of a harmonic overtone generation/synthesizing unit 104;

FIG. 4 is a block diagram showing a principal part of a harmonic overtone generation/synthesizing unit 104A according to a first modification of the harmonic overtone generation/synthesizing unit 104;

FIG. 5 is a block diagram showing a principal part of a harmonic overtone generation/synthesizing unit 104B according to a second modification of the harmonic overtone generation/synthesizing unit 104;

FIG. 6 is a block diagram showing a principal part of a harmonic overtone generation/synthesizing unit 104C according to a third modification of the harmonic overtone generation/synthesizing unit 104;

FIG. 7 is a block diagram showing a principal part of a harmonic overtone generation/synthesizing unit 104D according to a fourth modification of the harmonic overtone generation/synthesizing unit 104;

FIG. 8 is a block diagram showing a principal part of a harmonic overtone generation/synthesizing unit 104E according to a fifth modification of the harmonic overtone generation/synthesizing unit 104;

FIG. 9 is a flowchart for describing the processing procedure used by the encoding device according to the first embodiment of the present invention;

FIG. 10 is a graph for describing harmonic generation; and

FIG. 11 is a block diagram showing an example configuration of a music player system according to a second embodiment of the present invention.

### DETAILED DESCRIPTION

In the following, the present invention will be described in detail with reference to drawings. In the drawings referred to in the following, like parts are denoted by like reference numerals and their descriptions are omitted where appropriate to avoid duplication.

### First Embodiment

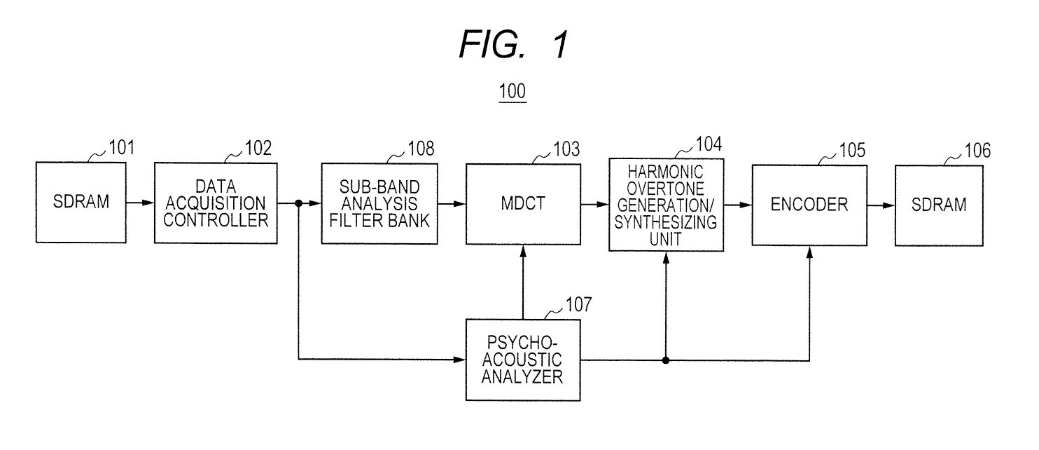

FIG. 1 is a block diagram showing an example configuration of an audio encoding device 100 according to a first embodiment of the present invention. Referring to FIG. 1, the audio encoding device 100 includes a memory, for example, an SDRAM (synchronous dynamic random access memory) 101 used as an input buffer, a data acquisition controller 102, a sub-band analysis filter bank 108, an MDCT (modified discrete cosine transform) 103, a harmonic overtone generation/synthesizing unit 104, an encoder 105, a memory, for example, an SDRAM 106 used as an output buffer, and a psycho-acoustic analyzer 107 which gives absolute thresholds of hearing and masking values to the MDCT 103, harmonic overtone generation/synthesizing unit 104 and encoder 105.

The SDRAM 101 is a buffer for temporarily storing data to be encoded, for example, music data. The SDRAM 106 is a buffer for temporarily storing encoded data. The SDRAM 101 and the SDRAM 106 may each be a semiconductor memory, or they may be provided in different regions of one semiconductor memory.

The data acquisition controller 102 acquires a predetermined number of frames, for example, one frame of data stored in the SDRAM 101 and outputs the acquired data to the sub-band analysis filter bank 108. The sub-band analysis filter bank 108 divides the frame of data received from the data acquisition controller 102 into sub-bands and outputs the sub-band data to the MDCT 103.

The MDCT 103 calculates MDCT coefficients of the sub-band data received from the sub-band analysis filter bank 108.

The psycho-acoustic analyzer 107 subjects audio data to FFT (fast Fourier transform) and calculates, based on frequency spectrums, absolute thresholds of hearing and masking values. Based on the information thus calculated, the psycho-acoustic analyzer 107 controls the harmonic overtone generation/synthesizing unit 104 and the encoder 105 thereby allowing the encoder 105 to determine the bits to be allocated to each scale factor band.

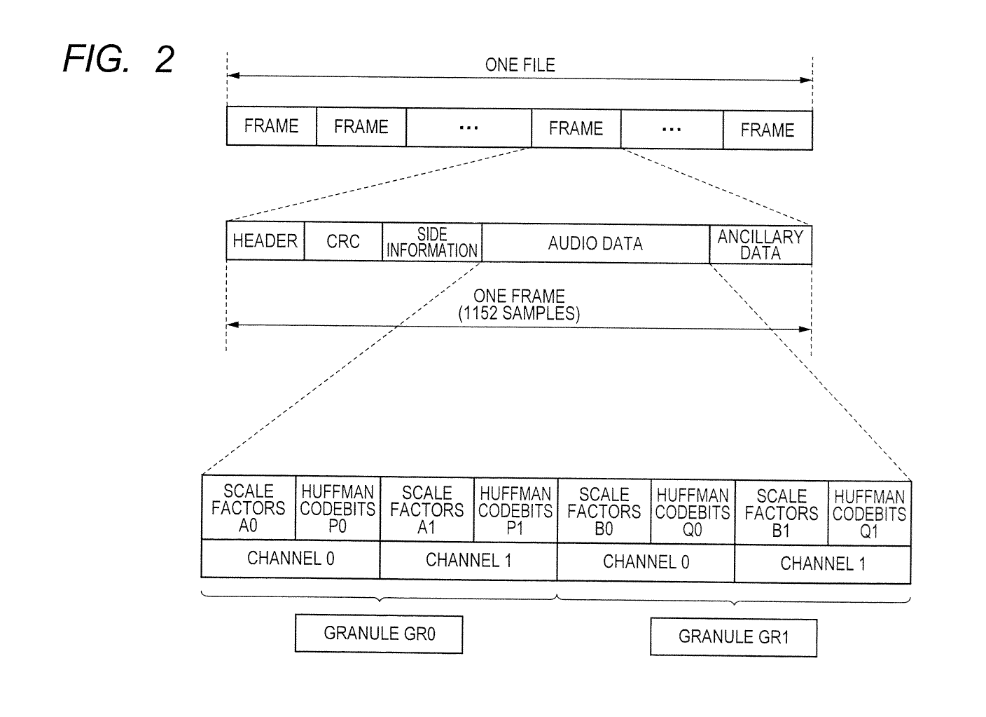

FIG. 2 shows an example of data format configuration for compressed data (stream). With reference to FIG. 2, the configuration of MP3 (MPEG1 Audio Layer 3) compressed data generated in an embodiment of the present invention will be described.

MP3 data (file) normally includes plural frames with each frame having 1,152 samples (in the case of MPEG1 Audio Layer 3). Each frame includes a header, an optional CRC for error prevention, audio data including integer values called scale factors and Huffman codebits which characterize music, side information including, for example, data characterizing music data to be compressed and auxiliary information to be used in compressing music data, and ancillary data including auxiliary data provided at the end of each frame. Each frame includes two granules with each granule having 576 samples.

In the audio data, granule GR0 is the earlier one of the two granules and granule GR1 is the later one of the two granules.

Granule GR0 is configured with channel 0 and channel 1 corresponding to stereo audio with each channel including scale factors and Huffman codebits. To be more specific, channel 0 includes scale factor A0 and Huffman codebits P0 and channel 1 includes scale factor A1 and Huffman codebits P1.

Granule GR1 is configured, similarly to granule GR0, with channel 0 and channel 1 corresponding to stereo audio with each channel including scale factors and Huffman codebits. To be more specific, channel 0 includes scale factor B0 and Huffman codebits Q0 and channel 1 includes scale factor B1 and Huffman steam Q1.

Referring to FIG. 1 again, the encoder 105 quantizes, on a scale factor band basis and according to a determined masking value, the data component including harmonic overtones generated at the harmonic overtone generation/synthesizing unit 104 or the original MDCT-processed data. Though not shown, the encoder 105 is assumed to be capable of performing sound processing such as butterfly calculations and stereo processing prior to quantization. Furthermore, the encoder 105 has a function to manage, based on the amount of code generated as a result of encoding performed thereby, the excess bit rate (amount of code) as a carryover for allocation to the subsequent frames.

The encoder 105 encodes the frame data included in the signal component, including harmonic overtones, of each scale factor band outputted from the harmonic overtone generation/synthesizing unit 104 in a manner to achieve a predetermined target bit rate (amount of code) and writes the encoded data to the SDRAM 106.

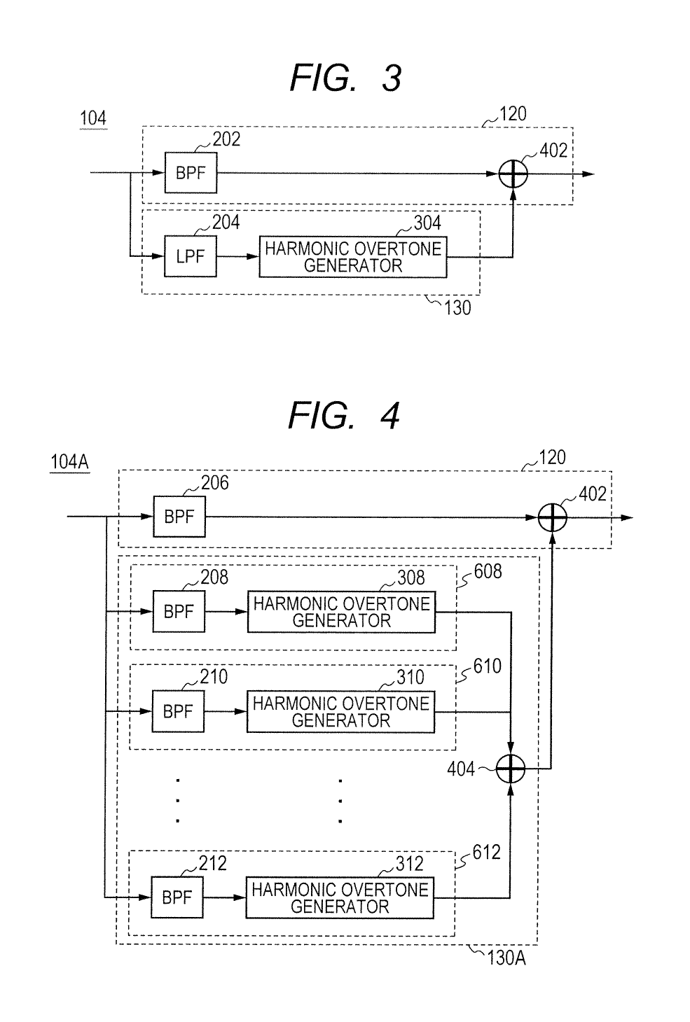

FIG. 3 is a block diagram showing a principal part of the harmonic overtone generation/synthesizing unit 104. Referring to FIG. 3, the harmonic overtone generation/synthesizing unit 104 includes a waveform synthesizing unit 120 and a harmonic wave generator 130. The input terminals of the waveform synthesizing unit 120 and harmonic wave generator 130 each receive a signal outputted from the MDCT 103. The signal outputted from the harmonic wave generator 130 is supplied to the waveform synthesizing unit 120.

The harmonic wave generator 130 includes an LPF (low-pass filter) 204 and a harmonic overtone generator 304. The LPF 204 receives a signal outputted from the MDCT 103 and extracts, from the received signal, a signal to be used as a fundamental wave for harmonic generation. The harmonic overtone generator 304 generates harmonics (harmonic overtone processing) each having a frequency equaling a positive integer multiple of a frequency which is in a low-frequency component extracted by the LPF 204 and which is determined by the psycho-acoustic analyzer 107 to have a power spectrum not lower than the absolute threshold of hearing and to exceed the masking value. When no such frequency component exists, the harmonic overtone generation/synthesizing unit 104 is required to perform none of filtering, harmonic generation, and synthesizing harmonics with the original signal. Whether such frequency component exists or not is determined in terms of a predetermined fundamental frequency by the psycho-acoustic analyzer 107.

The waveform synthesizing unit 120 includes a BPF (band pass filter) 202 which receives the output of the MDCT 103 and extracts, from the received output signal, only the frequencies of a high-frequency component and a synthesizing unit, for example, an adder 402 which weightedly synthesizes the signals outputted from the harmonic wave generator 130 and BPF 202. The frequency component extracted by the BPF 202 is higher in frequency than the frequency component extracted by the LPF 204.

The harmonic overtone generator 304 may include, though not shown, an odd harmonic overtone generator which generates, based on the fundamental wave, a signal containing at least an odd harmonic overtone component and an even harmonic overtone generator which generates, based on the fundamental wave, at least an even harmonic overtone component. In such a case, the signals outputted from the odd harmonic overtone generator and the even harmonic overtone generator may be synthesized at a predetermined ratio. Signal grouping like this can reduce the amount of data processing. In cases where the fundamental frequency is 100 Hz, harmonic overtone generation may be limited up to the eighth harmonic including only 200 Hz, 400 Hz, 600 Hz and 800 Hz so as to reduce the amount of data processing.

The level of harmonic overtones to be generated is adjusted to be increasingly lower toward higher frequencies along the equal-loudness curve such that, at 2 kHz, the sound pressure level is 0 dB.

Though the harmonic overtone generator 304 has been described to output a signal including harmonic overtones, it may output a signal generated by weightedly synthesizing the signal including harmonic overtones and the fundamental wave signal. In this case, however, the output signal again contains a low-frequency component, so that it is necessary to provide a filter unit (for example, an HPF or BPF) for removing the low frequency component. The cutoff frequency of the HPF is set to be lower than the fundamental wave frequency based on the characteristics of speakers to be used.

The above configuration allows: the LPF 204 to extract a low-frequency component of the output of the MDCT 103; the harmonic overtone generator 304 to generate harmonics based on the extracted signal; and the adder 402 to generate an output wave containing no low-frequency component by weightedly synthesizing the harmonics and an output wave, out of the output wave of the MDCT 103, having a frequency band component higher than the frequency band extracted by the LPF 204.

Because of a missing fundamental phenomenon, human beings perceive that the output wave containing no low-frequency component contains a low-frequency component. In reality, with the low-frequency component removed from the output wave, the bit allocation for low frequencies is either not performed at the encoder 105 in the next stage or drastically reduced. As a result, more bits can be allocated in encoding high-frequency components (quantization). Hence, the audio data encoded according to the present embodiment has reduced quantization noise.

### Modifications

A first modification of the harmonic overtone generation/synthesizing unit 104 will be described below.

FIG. 4 is a block diagram showing a principal part of a harmonic overtone generation/synthesizing unit 104A according to a first modification of the harmonic overtone generation/synthesizing unit 104. Referring to FIG. 4, the harmonic overtone generation/synthesizing unit 104A includes a harmonic wave generator 130A instead of the harmonic wave generator 130 included in the harmonic overtone generation/synthesizing unit 104. In other respects, the harmonic overtone generation/synthesizing unit 104A is identical to the harmonic overtone generation/synthesizing unit 104. Hence, identical description will not be repeated below.

The input terminals of the waveform synthesizing unit 120 and harmonic wave generator 130A each receive a signal outputted from the MDCT 103. The signal outputted from the harmonic wave generator 130A is supplied to the waveform synthesizing unit 120.

The harmonic wave generator 130A includes a synthesizing unit, for example, an adder 404 which weightedly synthesizes the outputs of the first to nth harmonic wave generators 608, 610, - - - , 612.

The first harmonic wave generator 608 includes a BPF 208 and a harmonic overtone generator 308 which are coupled in series between a node to which the output signal of the MDCT 103 is supplied and the input node of the adder 404. The second to nth harmonic wave generators 610, - - - , 612 are configured identically to the first harmonic wave generator 608. Hence, their descriptions are omitted here.

A low-frequency component of the signal outputted from the MDCT 103 is divided into plural low-frequency components, and the first to nth harmonic wave generators 608, 610, - - - , 612 generate harmonic overtone signals based on the corresponding low-frequency components, respectively. For example, a low-frequency band of 0 to 100 Hz is divided into smaller bands each having a 10-Hz width and the harmonic wave generators corresponding to the 10-Hz wide bands generate harmonic overtone signals, respectively.

Note that the frequency component extracted by the BPF 202 included in the waveform synthesizing unit 120 is higher in frequency than the frequency components extracted by the BPF 208, BPF 210, - - - , BPF 212.

The signals outputted from the first to nth harmonic wave generators 608, 610, - - - , 612 are weightedly synthesized by the adder 404. The adder 402 weightedly synthesizes the signal outputted from the adder 404 and the signal outputted from the BPF 202 and outputs the synthesized harmonics to the encoder 105.

Though the first to nth harmonic wave generators 608, 610, - - - , 612 have been described to output signals including harmonic overtones, they may each output a signal generated by weightedly synthesizing the corresponding signal including harmonic overtones and the fundamental wave signal. In this case, however, their output signals again contain low-frequency components, so that it is necessary to provide filter units (for example, HPFs or BPFs) for removing the low frequency components. The cutoff frequency of each HPF is set to be lower than the fundamental wave frequency based on the characteristics of speakers to be used.

The above configuration allows: the BPF 208, BPF 210, - - - , BPF 212 to extract, from the low-frequency component outputted from the MDCT 103, plural low-frequency components, respectively; the harmonic overtone generators 308, 310, - - - , 312 to generate, based on the corresponding signals thus extracted, corresponding harmonics; and the adder 402 to generate an output wave containing no low-frequency component by weightedly synthesizing the harmonics thus generated and an output wave which is extracted by the BPF 202 from the output of the MDCT 103 and whose frequency band is higher than the frequency bands extracted by the BPF 208, BPF 210, - - - , BPF 212.

Because of a missing fundamental phenomenon, human beings perceive that the output wave containing no low-frequency components contains low-frequency components. In reality, with low-frequency components removed from the output wave, the bit allocation for low-frequency components is either not performed at the encoder 105 at the next stage or reduced. As a result, more bits can be allocated in encoding high-frequency components (quantization).

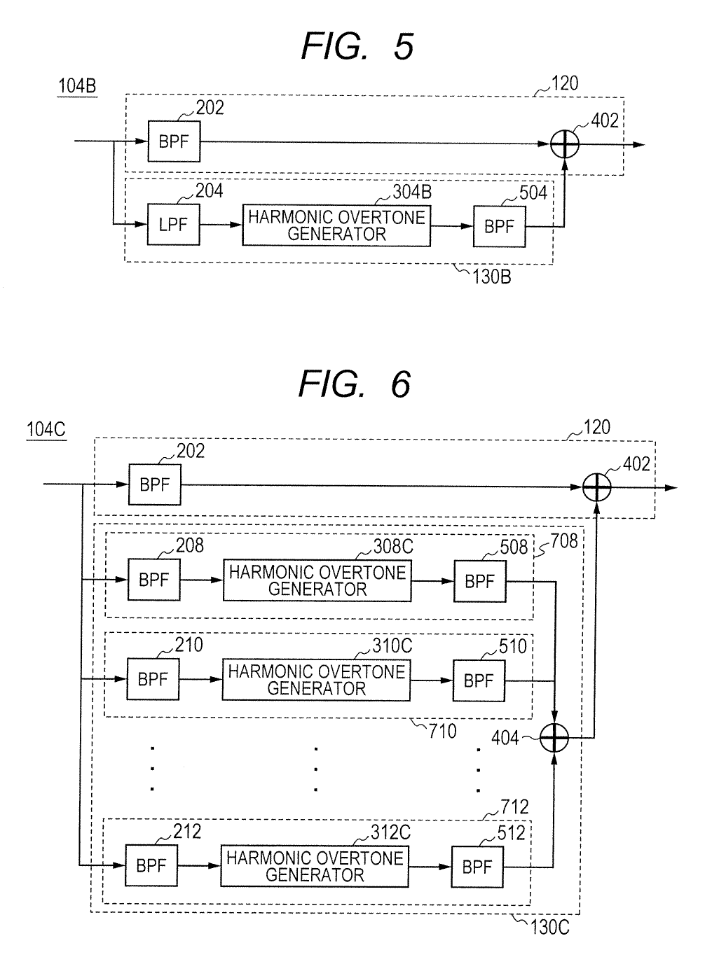

FIG. 5 is a block diagram showing a principal part of a harmonic overtone generation/synthesizing unit 104B according to a second modification of the harmonic overtone generation/synthesizing unit 104. Referring to FIG. 5, the harmonic overtone generation/synthesizing unit 104B includes a harmonic wave generator 130B instead of the harmonic wave generator 130 included in the harmonic overtone generation/synthesizing unit 104. In other respects, the harmonic overtone generation/synthesizing unit 104B is identical to the harmonic overtone generation/synthesizing unit 104. Hence, identical description will not be repeated below.

The harmonic wave generator 130B includes an LPF 204, a harmonic overtone generator 304B and a BPF 504. The LPF 204 receives the output signal of the MDCT 103 and extracts, from the output signal, a signal to be used as a fundamental wave for harmonic generation. The harmonic overtone generator 304B receives the signal including the fundamental wave extracted by the LPF 204, generates harmonics each having a frequency equaling a positive integer multiple of the fundamental wave frequency and outputs the harmonics after weightedly synthesizing them with the fundamental-wave frequency component. The BPF 504 passes the output signal of the harmonic overtone generator 304B excluding the fundamental-wave frequency component.

Thus, as described in connection with the harmonic overtone generation/synthesizing units 104 and 104A, when outputting a signal containing a fundamental wave as done by the harmonic overtone generator 304B, it is necessary to provide the BPF 504, i.e. a filter unit. The filter unit to be used is not limited to the BPF 504. An HPF which passes frequency components higher than a predetermined frequency may be used. The cutoff frequency of the HPF is to be set to be lower than the fundamental wave frequency based on the characteristics of speakers to be used.

FIG. 6 is a block diagram showing a principal part of a harmonic overtone generation/synthesizing unit 104C according to a third modification of the harmonic overtone generation/synthesizing unit 104. Referring to FIG. 6, the harmonic overtone generation/synthesizing unit 104C includes a harmonic wave generator 130C instead of the harmonic wave generator 130 included in the harmonic overtone generation/synthesizing unit 104. In other respects, the harmonic overtone generation/synthesizing unit 104C is identical to the harmonic overtone generation/synthesizing unit 104. Hence, identical description will not be repeated below.

The harmonic wave generator 130C includes a synthesizing unit, for example, an adder 404 which weightedly synthesizes the outputs of the first to nth harmonic wave generators 708, 710, - - - , 712.

The adder 404 weightedly synthesizes the output signals of the first to nth harmonic wave generators 708, 710, - - - , 712. The adder 402 weightedly synthesizes the output signal of the adder 404 and the output signal of the BPF 202, and outputs the synthesized harmonics to the encoder 105.

The first harmonic wave generator 708 includes a BPF 208, a harmonic overtone generator 308C and a BPF 508 which are coupled in series between a node to which the output signal of the MDCT is supplied and the input node of the adder 404. The second to nth harmonic wave generators 710, - - - , 712 are configured identically to the first harmonic wave generator 708. Hence, their descriptions are omitted here.

The low-frequency component of the signal outputted from the MDCT 103 is divided into plural low-frequency components and the first to nth harmonic wave generators 708, 710, - - - , 712 generate, based on the corresponding low-frequency components, corresponding harmonics, respectively. For example, a low-frequency band of 0 to 100 Hz is divided into smaller bands each having a 10-Hz width and the harmonic wave generators corresponding to the 10-Hz wide bands generate harmonic overtone signals, respectively.

Note that the frequency component extracted by the BPF 202 included in the waveform synthesizing unit 120 is higher in frequency than the frequency components extracted by the BPF 208, BPF 210, - - - , BPF 212.

The harmonic overtone generators 308C, 310C, - - - , 312C included in the harmonic wave generator 130C each output a signal generated by weightedly synthesizing harmonics each having a frequency equaling a positive integer multiple of the fundamental wave frequency extracted by the corresponding one of the BPFs 208, 210, - - - , 212 and the fundamental wave.

Thus, as described in connection with the harmonic overtone generation/synthesizing units 104 and 104A, when outputting signals each containing a fundamental wave as in the case of the harmonic overtone generator 304B, it is necessary to provide filter units like the BPFs 508, 510, - - - , 512. The filter units to be used are not limited to the BPFs 508, 510, - - - , 512. HPFs which pass frequency components higher than predetermined frequencies may be used. The cutoff frequencies of the HPFs are to be set to be lower than the fundamental wave frequency based on the characteristics of speakers to be used.

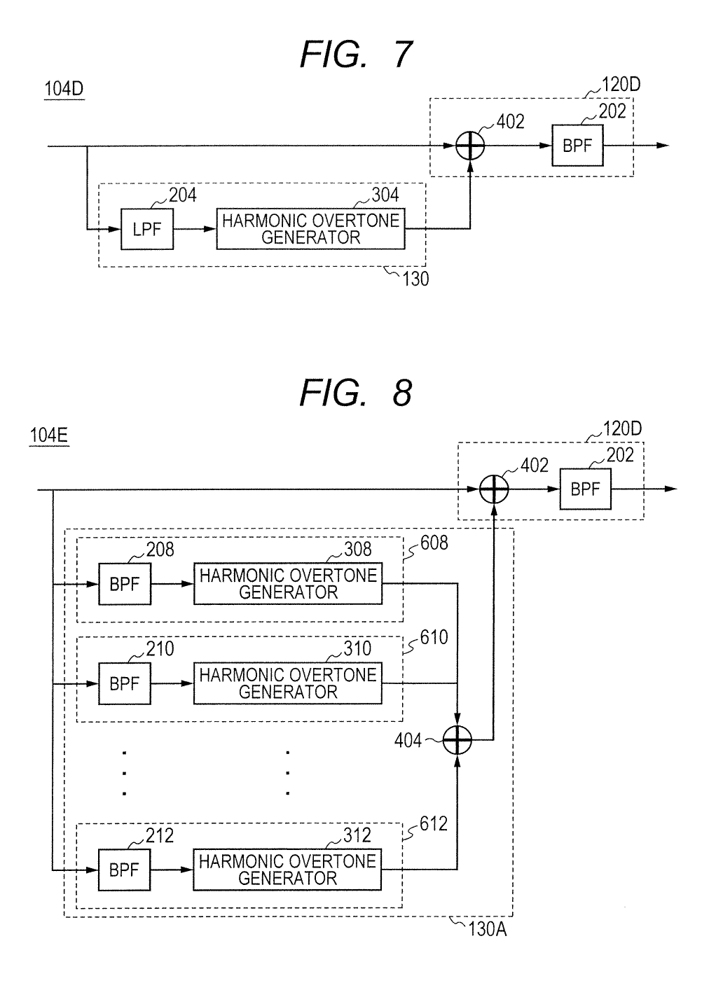

FIG. 7 is a block diagram showing a principal part of a harmonic overtone generation/synthesizing unit 104D according to a fourth modification of the harmonic overtone generation/synthesizing unit 104. Referring to FIG. 7, the harmonic overtone generation/synthesizing unit 104D includes a waveform synthesizing unit 120D instead of the waveform synthesizing unit 120 included in the harmonic overtone generation/synthesizing unit 104. In other respects, the harmonic overtone generation/synthesizing unit 104D is identical to the harmonic overtone generation/synthesizing unit 104. Hence, identical description will not be repeated below.

The waveform synthesizing unit 120D will be described in comparison with the waveform synthesizing unit 120 included in the harmonic overtone generation/synthesizing unit 104 shown in FIG. 3. The waveform synthesizing unit 120D includes an adder 402 and a BPF 402. The adder 402 can add the output waveform of the MDCT 103 and the output waveform of the harmonic wave generator 130. The waveform outputted from the adder 402 can have a low-frequency component removed therefrom by the BPF 202. Thus, the effects generated by the BPF 202 and BPF 504 included in the harmonic overtone generation/synthesizing unit 104B can be generated using one BPF. The filter unit to be used is not limited to the BPF 202. It may be replaced by an HPF. The cutoff frequency of the HPF is to be set to be lower than the fundamental wave frequency based on the characteristics of speakers to be used.

FIG. 8 is a block diagram showing a principal part of a harmonic overtone generation/synthesizing unit 104E according to a fifth modification of the harmonic overtone generation/synthesizing unit 104. Referring to FIG. 8, the harmonic overtone generation/synthesizing unit 104E has a configuration in which the waveform synthesizing unit 120D included in the harmonic overtone generation/synthesizing unit 104D shown in FIG. 7 and the harmonic wave generator 130A included in the harmonic overtone generation/synthesizing unit 104A shown in FIG. 4 are combined, so that effects similar to those generated using the waveform synthesizing unit 120D and the harmonic wave generator 130A can be generated. The description of each configuration will not be repeated here. The BPFs 208, 210, - - - , 212 can be combined into one similarly to the example shown in FIG. 7.

The configuration of the audio encoding device has been described with reference to FIG. 1 and other drawings. The processing procedure used by the audio encoding device will be broadly described in the following.

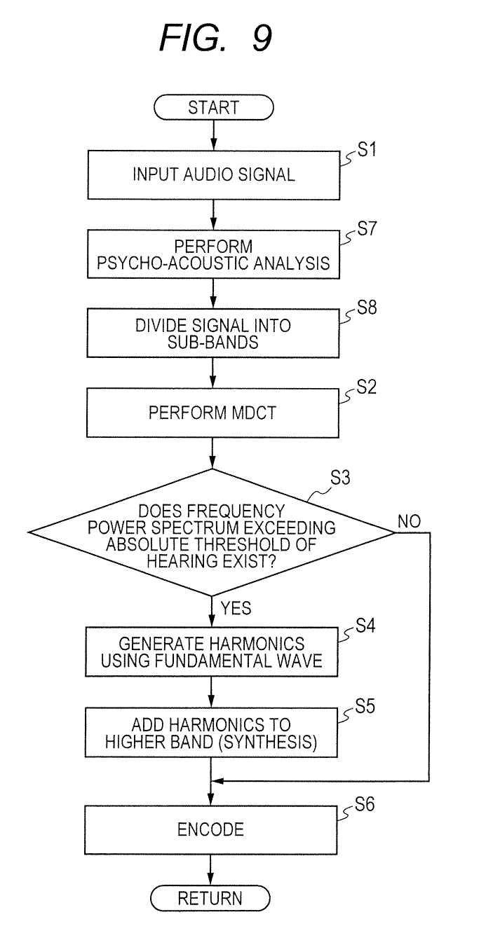

FIG. 9 is a flowchart for describing the processing procedure used by the encoding device according to the first embodiment of the present invention. Referring to FIG. 9, in step S1 following a start of encoding processing, audio (PCM) data inputted from outside is buffered in the SDRAM 101, and the data acquisition controller 102 acquires one frame or plural frames of data from the audio data stored in the SDRAM 101. Processing then advances to step S7.

In step S7, the psycho-acoustic analyzer 107 calculates absolute thresholds of hearing and masking values.

In step S8, one frame of data is divided into sub-bands. The data acquisition controller 102 increments the count of acquired frames by one to update the count.

In step S2, the MDCT 103 subjects the sub-band data calculated at the sub-band analysis filter bank 108 to MDCT.

In step S3, the psycho-acoustic analyzer 107 determines, based on the absolute thresholds of hearing and masking values calculated in step S7, whether or not the low-frequency component includes a frequency component with a power spectrum exceeding the respective thresholds and thereby determines a fundamental frequency to be a basis for harmonic overtone generation.

For example, when the power spectrum at 50 Hz of the output wave resulting from FFT is of only 15 dB not to exceed 30 dB, i.e. the absolute threshold of hearing at 50 Hz (0 dB 1 kHz), the psycho-acoustic analyzer 107 determines that the audio power is not enough to be audible, so that the waveform at 50 Hz is not extracted as a fundamental frequency. On the other hand, when the power spectrum at 100 Hz of the output wave resulting from FFT is of 38 dB to exceed 25 dB, i.e. the absolute threshold of hearing at 100 Hz (0 dB=1 kHz), the psycho-acoustic analyzer 107 determines that the audio power is enough to be audible and compares the power spectrum with the masking value. When, as a result of the comparison, it is determined that the masking effect makes the power spectrum audible, the frequency 100 Hz is determined to be a fundamental frequency. Plural fundamental frequencies may be determined each as a basis for harmonic overtone generation.

When a frequency component with a power spectrum exceeding the thresholds exists, processing advances to step S4. When no such frequency component exists, processing skips to step S6 without performing additional processing of steps S4 and S5. In step S6, bits are allocated for data quantization and data is quantized based on the absolute thresholds of hearing and the masking values calculated in step S7.

In step S4, based on the fundamental wave determined in step S3, the harmonic overtone generator shown in FIG. 1 generates harmonics each having a frequency equaling a positive integer multiple of the fundamental wave frequency.

The processing performed in step S4 is as follows.

Based on the fundamental wave determined in step S3, harmonics are generated. When a harmonic having a frequency equaling the fundamental wave frequency (i.e. 100 Hz in the present example) multiplied by a positive integer n (n being 2 or larger) is referred to as the nth harmonic, the positive integer n is preferably determined such that the frequencies of harmonics to be used as harmonic overtones fall around 2 kHz, even though it is possible to generate harmonics having higher frequencies. In the present example, the harmonics may range from the second to the 20th. The “2 kHz” is preferred because the absolute threshold of hearing is low at 2 kHz, that is, sound can be heard with high sensitivity (easily heard) at around 2 kHz, so that harmonics having frequencies of around 2 kHz make it easier for human beings to perceive low-frequency sound which is not, in reality, reproduced.

Also, as described in the foregoing, based on an equal-loudness curve, the absolute threshold of hearing becomes 0 dB at 2 kHz. Furthermore, when the fundamental frequency is 150 Hz, the lower cutoff frequency may be set to about 150 Hz for the original audio data before being processed by the harmonic overtone generation/synthesizing unit. When the fundamental wave is of 300 Hz, up to the fifth harmonic may be generated. This is to add, before the original voice loses low-frequency information by being compressed, the harmonics to a band which allows the original voice to be faithfully perceived.

In the case of MP3, for MDCT with a frequency resolution of 576 lines, the number of scale factor bands is 21 and the boundary frequency of the lowest frequency band at a sampling frequency of 44.1 kHz is 150 Hz. Namely, a fundamental frequency of 150 Hz is assumed. This means that bits for one band can be allocated to another band requiring more bits.

For example, when a fundamental wave frequency of 150 Hz is used as a base (fundamental frequency), harmonics with frequencies 300 Hz, 450 Hz, 600 Hz, 750 Hz, 900 Hz, 1050 Hz, - - - , and 1950 Hz can be generated. Alternatively, when a fundamental frequency of 300 Hz is used as a base, harmonics with frequencies 600 Hz, 900 Hz, 1200 Hz, 1500 Hz, and 1800 Hz (or up to the sixth harmonic) can be generated.

Or, when a fundamental frequency exceeding 150 Hz is adopted, the lower cutoff frequency may be set, taking speaker characteristics into consideration, to about 50 Hz or lower for the voice before being processed by the harmonic overtone generation/synthesizing unit.

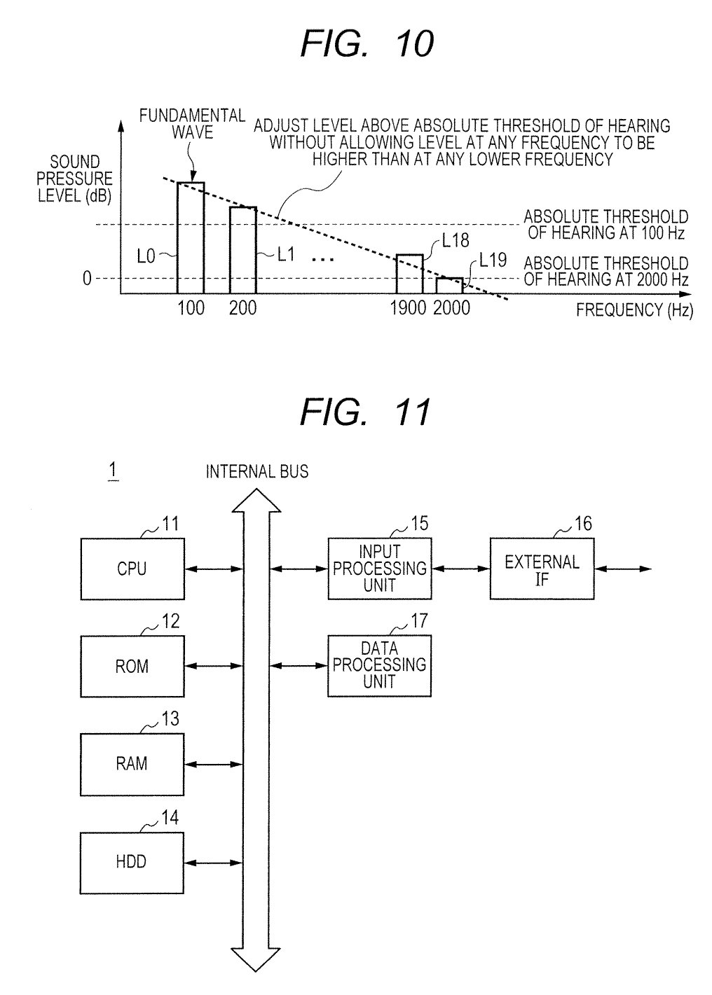

FIG. 10 is a graph for describing harmonic generation. In the graph of FIG. 10, the horizontal axis represents frequency and the vertical axis represents sound pressure level. In the graph, a broken line representing a hearing threshold (absolute threshold of hearing) is also shown to facilitate description.

For a fundamental wave of 100 Hz, sound pressure level L0 is shown. The sound pressure level L0 is extracted by the harmonic overtone generation/synthesizing unit 104. The sound pressure level L0 has an intensity exceeding the absolute threshold of hearing.

The power spectrums L1, L2, - - - , L18, L19 of the harmonics each generated by multiplying the fundamental wave frequency by a positive integer are also shown in the graph. The intensity of the power spectrums L1, L2, - - - , L18, L19 is gradually attenuated without going below the absolute threshold of hearing at 2000 Hz.

The harmonics are preferably generated such that the sound pressure level is 0 dB at 2000 Hz. For the sake of processing efficiency, the harmonics to be generated may be limited to, for example, even-number degrees or odd-number degrees or the second to fifth degrees.

Referring to FIG. 9 again, after harmonics are generated using the fundamental wave in step S4, the harmonic overtone generation/synthesizing unit 104 in step S5 synthesizes the harmonics generated and, out of the output wave of the MDCT 103, the output wave of a frequency component higher in frequency than the fundamental wave. The harmonic overtone generation/synthesizing unit 104 then outputs the synthesized wave to the encoder 105. Processing then advances to step S6.

In step S6, based on the output wave of the harmonic overtone generation/synthesizing unit 104, the encoder 105 performs encoding processing. In performing encoding processing, the encoder 105 decrease the bits allocated to the low-frequency component in which audio information has been reduced as a result of frequency shifting and increases the bits allocated to the high-frequency component. When step S6 is finished, processing is terminated.

As described above, for the low-frequency component with audio information reduced as a result of frequency shifting, audio information can be gathered in a high frequency component including harmonic overtones prior to encoding processing. This enables efficient encoding processing.

With audio information gathered in a high-frequency component including harmonic overtones, the encoding bit allocation for low-frequency components, low-frequency scale factor bands or small power-spectrum scale factor bands can be made unnecessary or can be reduced. As a result, more encoding bits can be allocated for encoding of scale factor bands with larger amounts of information.

Furthermore, control is performed to prevent scale factor band information from being distributed between bands after addition of harmonic overtones, and encoding is performed after harmonic overtones generated based on a low-frequency component are added to a band allocated with many bits. This makes it possible to reduce the bits required for scale factor transmission. The scale factor bits can also be reduced by having ancillary data containing scale factor band information shared between granules.

The configuration of the first embodiment enables the required number of bits to be reduced, and redundancy reduction and efficient bit-requirement control as described above makes it possible to improve sound quality and processing efficiency.

### Second Embodiment

A second embodiment of the present invention relates to a music player system using the encoding device described in connection with the first embodiment.

FIG. 11 is a block diagram showing an example configuration of a music player system according to a second embodiment of the present invention. The music player system includes a CPU (central processing unit) 11 which controls the whole system, a ROM (read-only memory) 12, a RAM (random access memory, for example, SDRAM) 13, an HDD (hard disk) 14, an input processing unit 15, an external IF 16, and a data processing unit 17.

The CPU 11 reads, via an internal bus, various programs stored in the ROM 12, transfers the programs to the RAM 13, and controls, by executing the programs, the whole music player system. When a command is received from the input processing unit 15, the CPU 11 executes the corresponding operation by performing prescribed arithmetic processing.

The external IF 16 detects operation of an operation button by a user and outputs an operation input signal corresponding to the button operation to the input processing unit 15. When an operation input signal is received from the external IF 16, the input processing unit 15 converts the operation input signal into a command by performing prescribed processing and transfers the command to the CPU 11 via the internal bus.

The data processing unit 17 processes music data received from a media drive, for example, CDROM coupled to the external IF 16 for compression coding and stores the compression-coded music data in the hard disk 14. The data processing unit 17 also reproduces the music data in accordance with an operation by the user.

When reproducing music data in accordance with an operation by the user, the CPU 11 outputs a music data reproduction command to the data processing unit 17 and, at the same time, reads the specified music data stored in the hard disk 14 and transfers the music data to the data processing unit 17. The data processing unit 17 decodes and reproduces the music data transferred from the hard disk 14 for output from, for example, a speaker (not shown). The audio encoder 100 described for the first embodiment is provided in the data processing unit 17.

By executing various programs stored in the RAM 13, the CPU 11 generates display data and transfers the display data to a display processing unit (not shown) or reads music-related information (for example, music titles) stored in the hard disk 14 and transfers the music-related information to the display processing unit (not shown). When display data is received from the CPU 11, the display processing unit (not shown) displays, based on the display data, music-related information.

As described above, according to the music player system of the second embodiment, the audio encoding device 100 described for the first embodiment is provided in the data processing unit 17, so that a system which can generate the effects described in connection with the first embodiment can be configured.

The music player system (for music data encoding) of the second embodiment has been described. The audio encoder 100 described for the first embodiment can also be applied to an image reproduction system (for image data encoding).

Finally, referring to drawings, the first and second embodiments will be summed up below.

As shown in FIG. 1, the audio encoding device 100 of the first embodiment includes a storage unit (for example, SDRAM 101) which stores audio data, a data acquisition controller 102 which acquires audio data from the storage unit, a sub-band analysis filter bank 108 including a series of filters for frequency-transforming the audio data outputted from the data acquisition controller 102, an MDCT 103, a harmonic overtone generation/synthesizing unit 104 which generates harmonics based on a first output wave included in the output wave of a transformation unit and synthesizes the harmonics generated and a second output wave included in the output wave of the transformation unit, the second output wave being a higher frequency component than the first output wave, and an encoder 105 which encodes the output of the harmonic overtone generation/synthesizing unit 104. The audio encoding device 100 of the first embodiment further includes a psycho-acoustic analyzer 107 which calculates masking values and, based on the masking values, controls the MDCT 103 and the harmonic overtone generation/synthesizing unit 104.

In the audio encoder 100, the storage unit (for example, SDRAM 101) further stores sound pressure level thresholds corresponding to frequencies and, when the sound pressure level corresponding to the first output wave is higher than the corresponding threshold, generates harmonics based on the first output wave.

Preferably, as shown in FIGS. 3 to 8, in the audio encoder 100, the harmonic overtone generation/synthesizing unit 104 includes a harmonic wave generator 130 which generates, based on the frequency of the first output wave, harmonics each having a frequency equaling a positive integer multiple of the frequency of the first output wave and a waveform synthesizing unit 120 which synthesizes the harmonics and the second output wave.

Furthermore, preferably, in the audio encoding device 100, when the sound pressure level corresponding to the first output wave is larger than a corresponding threshold, the harmonic wave generator 130 generates harmonics based on the first output wave.

Still further, preferably, as shown in FIGS. 3 and 4, in the audio coding device 100, the harmonic wave generator 130 includes a first filter circuit (for example, LPF 204 or BPF 208 to BPF 212) which extracts the first output wave based on the output wave of the transformation unit, harmonic overtone generators 304 and 308 to 312 which generate harmonics each having a frequency equaling a positive integer multiple of the output wave frequency of the first filter circuit, a second filter circuit BPF 202 which extracts the second output wave based on the output wave of the transformation unit, and an adder 402 which synthesizes the harmonics and the output wave of the second filter circuit and outputs the synthesized wave.

Still further, preferably, as shown in FIGS. 3 to 6, in the audio encoding device 100, the waveform synthesizing unit 120 includes a third filter circuit BPF 202 which extracts, based on the output wave of the transformation unit, an output wave having a frequency higher than the frequency inputted to the harmonic wave generator 130 and an adder 402 which synthesizes the harmonics generated and the output wave of the third filter circuit and outputs the synthesized wave.

Still further, preferably, as shown in FIGS. 7 and 8, in the audio encoding device 100, the waveform synthesizing unit 120D includes an adder 402 which synthesizes the harmonics and the output wave of the transformation unit and outputs the synthesized wave and a third filter circuit BPF 202 which extracts, from the output wave of the transformation unit, an output wave having a frequency higher than the frequency inputted to the harmonic wave generator 130.

Still further, preferably, as shown in FIG. 11, the semiconductor device of the second embodiment includes the audio encoding devices 100 described as an example of the first embodiment.

The above embodiments of the present invention should be considered in all respects as illustrative and not restrictive. The scope of the invention is defined by the appended claims, rather than the foregoing description, and all changes within the meaning and range of equivalency of the claims are embraced therein.

What is claimed is:

1. An audio encoding device, comprising:
a storage unit which stores audio data;
a data acquisition controller which acquires the audio data from the storage unit;
a transformation unit which processes an audio data signal outputted from the data acquisition unit for frequency transformation;
a harmonic overtone generation/synthesizing unit which generates a harmonic based on a first output wave out of an output wave of the transformation unit and synthesizes the harmonic and a second output wave out of the output wave of the transformation unit, the second output wave being higher in frequency than the first output wave; and
an encoder which subjects an output from the harmonic overtone generation/synthesizing unit to encoding processing.

2. The audio encoding device according to claim 1,
wherein the storage unit further stores frequency-based sound pressure level thresholds, and
wherein, when the sound pressure level corresponding to the first output wave exceeds the corresponding threshold, the harmonic overtone generation/synthesizing unit generates the harmonic based on the first output wave.

3. The audio encoding device according to claim 2, wherein the harmonic overtone generation/synthesizing unit includes:
a harmonic wave generator which generates, based on a frequency of the first output wave, a harmonic having a frequency equaling a positive integer multiple of the first output wave frequency; and
a waveform synthesizing unit which synthesizes the harmonic and the second output wave.

4. The audio encoding device according to claim 3, wherein, when the sound pressure level exceeds the corresponding threshold, the harmonic wave generator generates the harmonic based on the first output wave.

5. The audio encoding device according to claim 4, wherein the harmonic wave generator includes:
a first filter circuit which extracts the first output wave based on the output wave of the transformation unit;
a harmonic overtone generator which generates the harmonic having a frequency equaling a positive integer multiple of the output wave frequency of the first filter circuit;
a second filter circuit which extracts the second output wave based on the output wave of the transformation unit; and
a synthesizing unit which synthesizes the harmonic and the output wave of the second filter circuit and outputs the synthesized waveform.

6. The audio encoding device according to claim 4, wherein the waveform synthesizing unit includes:
a third filter circuit which extracts, from the output wave of the transformation unit, an output wave having a frequency higher than a frequency inputted to the harmonic wave generator; and
a synthesizing unit which synthesizes the harmonic and the output wave of the third filter circuit and outputs the synthesized wave.

7. The audio encoding device according to claim 4, wherein the waveform synthesizing unit includes:
a synthesizing unit which synthesizes the harmonic and the output wave of the transformation unit and outputs the synthesized wave, and
a third filter circuit which extracts an output wave having a frequency higher than a frequency inputted to the harmonic wave generator.

8. A semiconductor device comprising the audio encoding device according to claim 1.
